(19) United States
(12) Patent Application Publication
(10) Pub. No.: US 2017/0036201 A1
(43) Pub. Date: Feb. 9, 2017

(54) SORDS PURIFICATION by LBPSE A System And Method For Processing Backwashed Catalyst Ret

(71) Applicant: CAT' FINE MANAGEMENT TECHNOLOGIES, LLC, Liberty, TX (US)

(72) Inventor: Larry Joseph WEBER, Liberty, TX (US)

(21) Appl. No.: 15/304,443

(22) PCT Filed: Apr. 14, 2015
(86) PCT No.: PCT/US15/25777

§ 371 Date: Oct. 14, 2016

Related U.S. Application Data
(60) Provisional application No. 61/995,534, filed on Apr. 14, 2014.

(51) Int. Cl. B01J 38/48; B01D 17/02; B01D 21/00; B01D 29/52; F26B 17/02; B01D 29/66; B01D 24/46; B01D 24/00; B01D 1/00; C10G 11/18; B03C 5/02

(52) U.S. Cl. CPC B01J 38/48; C10G 11/18; C10G 11/182; B01D 17/0208; B01D 21/00; B01D 29/52; B03C 5/02; B01D 29/66; B01D 24/4631; B01D 24/002; B01D 17/02; B01D 1/0011; F26B 17/023

(57) ABSTRACT

A method for separating catalyst particles from the FCC slurry oil present in the retentate of a filtered FCC slurry oil run-down stream is disclosed. The method comprises backwashing the run-down stream filter with a low boiling point solvent to extract slurry oil from the catalyst in the retentate. The backwash solution is sent to a digester where the catalyst fines are separated from the hydrocarbon component (solvent and slurry oil). The catalyst fines are collected and dried. The dried catalyst fines can be transported via pneumatic systems, and can be regenerated for further use as FCC catalysts. The solvent vapor from the drying process is collected for potential reuse. The hydrocarbon component is sent from the digester to an evaporator to evaporate the solvent from the slurry oil. The FCC slurry oil and the solvent exiting the evaporator can be independently collected. The solvent from the evaporator can be reused in the process.

### RELATED APPLICATIONS

This application is the US National Stage under 35 USC §371 of International App. No. PCT/US2015/025777 which claims priority to U.S. Application No. 61/995,534 entitled “SORDS Purification by LBPSE: A System And Method For Processing Backwashed Catalyst Retentate Filtered From The Slurry Oil Run-Down Stream (SORDS) Generated By The Fluid Catalytic Cracker” which was filed on Apr. 14, 2014 and which is incorporated herein by reference.

### TECHNICAL FIELD

The present invention relates to a System and Method for processing inorganic Fluid Catalytic Cracking (FCC) catalyst solids (a filtrand) backwashed from various filtration system designs that are placed along the FCC Slurry Oil Run-Down Stream (SORDS) and which are generated by the Fluid Catalytic Cracking process. This filtrand material is a listed hazardous waste—K-170—as defined by the U.S. Resource Conservation and Recovery Act (RCRA). The processing of FCC cat' fine filtrands by the present method generates a dry catalyst powder amenable to handling by conventional pneumatic transport systems. This can be important in closing the environmental loop on the filtrand which would otherwise remain listed as a hazardous waste. The complete filtration and hazardous waste resolution hardware system is entitled the SORDS Purification Unit or SPU.

### ABBREVIATIONS

The following abbreviations are used throughout the Background, Description and Claims.

| | |
|---|---|
| APS | Average Particle Size |
| BS&W | Basic Sediment and Water |
| Cat' fines | Small catalyst particle resulting from impact and |
| | abrasion in the FCC process |
| CSO | Cat' Slurry Oil |
| Cat' | Catalyst |
| Cat' cracker | Fluid Catalytic Cracking Unit (FCC) |
| FCC | Fluid Catalytic Cracker |
| FCC-CFD | Fluid Catalytic Cracking - Catalyst Fine Desalting |
| FCCU | Fluid Catalytic Cracking Unit |
| LBPS | Low Boiling Point Solvent |
| LBPSE | Low Boiling Point Solvent Extraction |
| LCO | Light Cycle Oil |
| RCRA | Resource Conservation and Recovery Act |
| SPU | SORDS Purification Unit |
| SOCFBs | FCC Slurry Oil Catalyst Fine Bottoms |
| SORDS | FCC Slurry Oil Run-Down Stream |

### BACKGROUND ART

The problems presented by catalyst attrition from Fluid Catalytic Cracking Units (FCCU) have plagued the refining industry since the advent of fluid catalytic cracking in the first half of the 20th century. Over time, FCCU catalysts deteriorate in size. The size deteriorated catalysts are commonly referred to as “cat' fines”. For seven decades the petroleum refining industry has dealt with this issue in the same manner, i.e. “Let it make its way to the FCC slurry oil storage tank and get it later”. This practice has presented deleterious economic and environmental consequences not the least of which include health threatening issues associated with human entry into FCC slurry oil storage tanks.

In the FCC process, cracked product stream vapor and some catalyst, typically of small particle size vis-ã-vis the APS of new catalyst, leave the reactor and enter the main fractionator near its base. The fractionation tower bottoms stream from the FCC fractionator is called FCC slurry oil. The term “FCC slurry oil” has arisen as a result of the presence of catalyst particles in the distillation tower bottom's product. It is not a typical slurry as is commonly known. In rubbing a drop of FCC slurry oil between the forefinger and thumb (with protective gloves), only a very slight grittiness can be detected even by an experienced technician.

The cat' fines in the produced FCC slurry oil are typically present in the FCC slurry oil at a low concentration of 0.08% to 0.12% (800 ppm to 1200 ppm) under optimum processing conditions. This concentration has been observed to be as high as 2500 ppm in atypical cases. It is normal that, over the run of the FCCU, the volume of cat' fines that escape the FCC reactor increases. Ultimately the cat' fine particles make their way to the FCC slurry oil product storage tank. Once in the storage tank, the cat' fines settle to the storage tank bottom, albeit very slowly. This “innocuous” suspension of cat' fine particles in the FCC Slurry Oil Run-Down Stream, albeit at first-glance almost undetectable, results in significant accumulation of FCC Slurry Oil Cat' Fine Bottoms, hereinafter referred to as SOCFBs, in FCC slurry oil storage tanks. A typically sized cat' cracker will produce one half to one and one half US Tons (i.e., 1000 lbs to 3000 lbs) of FCC catalyst, present in the FCC slurry oil as cat' fine contamination, each day.

### Implications of Cat' Fine Contamination

FCC Slurry oil is a saleable product of FCC processing. However, the existence of catalyst fines in the FCC slurry oil product and ultimately as SOCFB's in the FCC slurry oil storage tank presents a variety of problems to the refiner. The immediate and obvious problem has to do with product quality. FCC Slurry oil has proven to be an ideal feedstock for carbon black and needle coke manufacture. Utilization as carbon black or needle coke feedstock escalates the value of FCC slurry oil product. However, the presence of catalyst fines above a specified percentage in the FCC slurry oil product results in an “ash content” in excess of the specification which is acceptable for use of the FCC slurry oil as a carbon black or needle coke feedstock. Even when the FCC slurry oil product is utilized as a fuel source, a “price penalty” is levied as ash content in the form of the inorganic catalyst fines increases. The typical FCC slurry oil product specification for use as feedstock to manufacture carbon black or needle coke is less than 400 parts per million (or less than 0.04%).

Firms within the specialty chemical industry that service the petroleum refining industry have built proprietary product lines designed to enhance settling of the catalyst fines in the FCC slurry oil storage tank. This is no more than a “band-aid fix”. In recently or relatively recently cleaned storage tanks this procedure can be successful in enabling the stored FCC slurry oil product to meet the specifications of carbon black or needle coke manufacturers for a time. However, as the accumulation of catalyst fines continues in the storage tank, a time comes when no amount of settling enhancement will permit the stored product to “meet specification” of carbon black or needle coke manufacturers or even fuel products.

A third factor that compels the control of SOCFB accumulation has to do with storage tank inspection criteria. Regulatory authorities require storage tank inspection at specified intervals. The presence of SOCFB's interferes with these inspections.

In 1998, FCC Slurry Oil Cat' Fine Bottoms were listed under provisions of the US Resource Conservation & Recovery Act as a hazardous waste and labeled K-170. The cost of disposal of SOCFBs jumped virtually overnight from $27.50 per ton to over $400 per ton when the regulation was enacted. Currently, disposal cost can be as high as $900 per ton. FCC catalyst fines backwashed from the FCC slurry oil run-down stream (SORDS) by various filtration hardware systems fall under the auspices of the RCRA K-170 listing.

### FCC Slurry Oil/Catalyst Fines Tank Bottoms Recovery & Processing

When accumulation of catalyst fines in the FCC slurry oil storage tank becomes intolerable, in terms of meeting product specification or inspection criteria, refinery management schedules a clean-out. The clean-out is typically conducted under one of two scenarios. One type of clean-out, referred to as a “partial clean-out” calls for the removal of the catalyst fines without human entry. In this instance, enough of the catalyst fine sediment is removed to reduce the level of accumulation in the storage tank and thus allow for enough settling room to enable FCC slurry oil to meet specification guidelines.

There are refineries, typically those of large production cat crackers (100,000 BPD or more), that conduct a never-ending partial FCC slurry oil storage tank clean-out exercise. The procedure is as follows: allow the cat' fines to settle in the storage tank, retrieve the cat' fines from the slurry tank internals, process the retrieved cat' fines to a hazardous waste non-conclusion, and start again the next day or next week. A 100,000 barrel per day (BPD) cat-cracker can generate the equivalent of about 0.7 U.S. Ton (UST) per day of cat' fine solids under optimum operating conditions. This equates to about 1.4 US Tons of SOCFBs per day.

The second type of clean-out, commonly referred to as a FCC slurry oil storage tank turn-around, entails a complete removal of all catalyst fine sediment in the form of SOCFBs, subsequent human entry for rigorous clean up and a so-called mop-up, all followed by inspection, repairs and return-to-service. It is a tedious, dangerous and health threatening exercise replete with potential human exposure to aromatic vapors.

The low API gravity/high density of the FCC slurry oil coupled with the entrained catalyst fines contributes to recovery and handling problems that are reputed to be some of the toughest in the tank cleaning industry. The tank cleaning industry has devised a number of procedures for catalyst fines removal from FCC slurry oil storage tanks. These include the injection of diluent at high pressure either via side ports or from the roof of the storage tank, the cutting of “door sheets” using a water torch and various probe insertion devices, etc. One such insertion device was co-invented by the present inventor and is called the SWEEPBER and is described in U.S. Pat. No. 6,142,160, which is incorporated herein by reference. As described therein, the SWEEPBER insertion device serves the purpose of recovering catalyst fines from the bottom of FCC slurry oil storage vessels without human entry.

A diluent is required to enhance ease of handling of the SOCFBs in most instances known to this inventor. The observed and preferred diluent of choice is Light Cycle Oil or LCO, a side-cut of the FCCU fractionator. The use of LCO, a valuable finished product, as diluent is extremely costly and can be the single largest cost associated with the resolution of accumulated cat' fines in FCC slurry oil storage tanks. Annualized, this may translate to a cost of about $1 million per year.

### Prior Methods for Filtration of the FCC Slurry Oil Run-Down Stream

The obvious solution to both FCC slurry oil storage tank SOCFB accumulation and meeting premium product specification is to filter the catalyst from the FCC Slurry Oil Run-Down Stream (SORDS). Within the last 20 years, after some 50 years of the “let it make its way to the storage tank and get it later” strategy, SORDS filtration systems have gained some popularity with the petroleum refining industry. Two of the more effective methods presently utilized in global refineries are porous metal filtration and electrostatic attraction. There are other approaches but all experience the issue of dealing with backwashed filtered catalyst, categorized as K-170, from the respective filtration system.

Prior Methods for Disposition of Backwash from SORDS Filtration Systems

One current method for dealing with SORDS filtrand/retentate disposition is to “stick it back in the cat feed,” i.e. recycle the SORDS filtrand/retentate. Since the backwash FCC slurry oil has already been cracked by the FCC process and since the catalyst constituent of the backwash is rendered inactive by a patina of coke (That is why the FCC process calls for regeneration of reactor-side catalyst); there is no benefit to be had from the recycled catalyst unless the catalyst is regenerated. Non-active catalyst particles displace active, regenerated catalyst thereby reducing overall conversion in the FCCU. If FCC slurry oil is used as the backwash diluent, then “crackable” catfeed is backed-out and displaced by “cracked-out” FCC slurry oil. This displacement translates to an economic cost that can easily exceed $1 million per year in lost fresh catfeed processing.

A second method of disposition of the backwash mixture is to simply backwash to a storage reservoir. Subsequently the K-170 mixture is transported away. Alternative disposition sites include landfill, cement kiln feedstock, or an incinerator.

### SUMMARY OF THE INVENTION

Briefly, disclosed herein is a third method for dealing with the backwash mixture which includes integrating K-170 Resolution Method disclosed in my U.S. application Ser. Nos. 61/461,163 and 13/352,328 filed Jan. 14, 2011 and Jan. 17, 2012 (which are incorporated herein by reference) with a proven SORDS Filtration System.

### Closing the Environmental Loop on Recovered Catalyst

The SORDS Purification Unit (SPU) purifies both the FCC Slurry Oil in the Run-Down Stream and any FCC Slurry Oil that is associated with filtration backwash. Low Boiling Point Solvent Extraction (LBPSE) produces dry, unregenerated catalyst that can be injected into the FCCU, preferably just upstream of the Regenerator. This catalyst, once regenerated, bears the activity of equilibrium catalyst or “E-Cat” because that is precisely what it is. There are two preferred disposition options available as a “closing of the loop” for the catalyst component of SOCFBs, i.e. the SORDS filtrand. The ideal option is to reinject the reclaimed catalyst, recovered by the K-170 Resolution method, into the FCCU at a point just upstream of the Regenerator. Any reinjected, reclaimed catalyst that attrites via the regenerator cyclones and scrubber system is rendered non-hazardous while off-setting makeup catalyst requirements as a result of “metal flushing”. The recycling into the FCCU option is invited when the reclaimed catalyst is provided in a dry powdered form amenable to existing pneumatic transport and handling systems characteristic of present day FCCUs.

An ideal situation occurs when an opportunity to cascade recovered catalyst to an alternate FCCU is presented. This occurs when there is significant differential, in terms of lesser catalyst activity requirement, between the reclaimed catalyst and the equilibrium catalyst typical of an alternate FCCU which requires less stringent catalyst activity.

A second industry-accepted option for recovered catalyst disposition is as a cement kiln feedstock. The primary chemical constituents of FCC catalyst are the oxides of silica and aluminum; the very same primary components of typical cement kiln feed. Catalyst reclaimed by the K-170 Resolution Method is especially qualified for this option because of the form in which it is reclaimed, i.e. as a free-flowing powdered material capable of being handled by standard cement kiln pneumatic systems. Catalyst reclaimed by the K-170 Resolution Method contains some hydrocarbon which serves to subsidize the BTU requirements of the cement kiln. Cement kiln operators typically charge refiners for accepting K-170 waste be it in the form of an oily cake, dry catalyst or other alternative forms

The method disclosed below separates and isolates catalyst particles from the hydrocarbon component of SORDS filtration systems simultaneous to extracting the FCC slurry oil, and, subsequently, extracts FCC slurry oil from the catalyst filtrand that has been backwashed by a low boiling point solvent (LBPS) from the upstream side of a FCC slurry oil filtration system. The preferred LBPS is, but is not limited to, dimethyl formaldehyde. In the present method, the low boiling point solvent (LBPS) is employed as the backwash diluent. This is distinct from current practices which employ hot LCO or FCC slurry oil as the backwash diluent stream. The backwash (containing catalyst, LBPS and any residual FCC slurry oil) is sent to a digester vessel. Digestion comprises mixing the backwash while the LBPS serves to dissolve and extract FCC slurry oil retained on the surface and in the pores of the FCC catalyst. Subsequent to backwashing, the FCC slurry oil/solvent/catalyst mixture (the backwash feed) is allowed to settle. Upon settling of the catalyst, the hydrocarbon portion, containing the FCC slurry oil and solvent, is decanted and sent through filters to a Heavy Oil Recovery (HOR) vessel where the solvent is evaporated from the FCC slurry oil. The FCC slurry oil reclaimed in the Heavy Oil Recovery Vessel is then sent to FCC slurry oil storage either by transport trucking or by reinjection into the FCC Slurry Oil Run-Down Stream, downstream of the FCC Slurry Oil filtration system. After decanting the hydrocarbon portion from the digester the remaining settled catalyst, moist with solvent, is heated in a procedure referred to as “fluffing”. Fluffing results in the vaporization of solvent which is directed through the LBPSE Condensation & Recovery step of the Process. In the “fluffing” process the catalyst is stripped of solvent leaving a dry powder. Fluffing may be performed by, but is not limited to, a Hollow Flight Dryer that provides heat for vaporization. Alternative methods for fluffing include a tumble dryer or microwave system.

### BRIEF DESCRIPTION OF THE DRAWINGS

FIG. 1 is a schematic flow diagram of the current method.

### DESCRIPTION OF THE PREFERRED EMBODIMENT

While the invention is susceptible of embodiment in many different forms, there is described in detail preferred embodiments of the claimed invention. It is to be understood that the present disclosure is to be considered only as an example of the principles of the claimed invention. This disclosure is not intended to limit the broad aspect of the claimed invention to the illustrated embodiments. The scope of protection should only be limited by the claims.

The present method typically includes eight (8) stages or steps, as follows:
1. Continuous Filtration of the FCC Slurry Oil Run-Down Stream;
2. Backwash of catalyst from the respective filtration system with a low boiling point solvent;
3. Digestion of the backwash mixture by mixing and subsequent settling of the catalyst;
4. Decanting of the upper, hydrocarbon layer containing LBPS and extracted FCC Slurry Oil;
5. Filtration of the decanted hydrocarbon layer;
6. Evaporation of LBPS from the FCC Slurry Oil;
7. Fluffing of the solvent-moist catalyst;
8. Condensation & Recovery of vaporized LBPS resulting from both the fluffing process and Evaporation of LBPS from the recovered FCC Slurry Oil.

In a broad overview of the present invention the resolution of the components of the back washing exercise, i.e. FCC slurry oil, catalyst retentate and solvent, are sent to a Digester vessel. The inorganic catalyst constituent, the solvent used for the filter backwash and extraction of FCC slurry oil from the catalyst surface and pores and the extracted residual FCC slurry oil are mixed/digested. After digestion, the solvent/catalyst-retentate/heavy-oil mixture is left to settle. The hydrocarbon layer is then decanted and filtered. The solvent is then distilled from the heavy oil with minimal thermal requirements. After decanting the hydrocarbon layer from the digester, the remaining settled catalyst, moist with solvent, is transferred to a heated conveyor where total vaporization of the solvent is assured and achieved in a procedure referred to as fluffing. The LBPS vapor product of evaporation, fluffing and heated transport is condensed, recovered and finally recycled back into the K-170 Resolution Process.

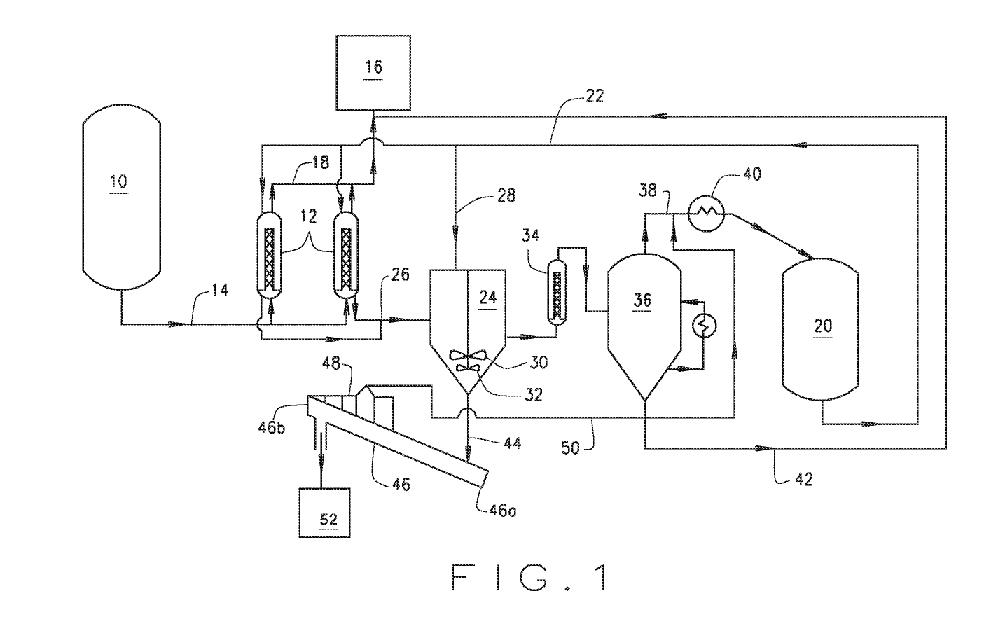

The flow of FCC Slurry oil from the FCCU Fractionator 10 in accordance with my “SORDS Purification by K-170 Resolution” method is shown schematically in the flow diagram of FIG. 1. The FCC Slurry Oil Run-down Stream (SORDS) is initially delivered to a bank of in line filter assemblies 12 by way of piping 14 and is directed to one of those filter assemblies. The FCC slurry oil from the FCCU fractionator 10 can be about 800 ppm to about 1200 ppm (about 0.08% to about 0.12%) catalyst. While only one filter assembly is needed, preferably, there are at least two filter assemblies 12 because the SORDS process is continuous and the filter assemblies must be periodically backwashed (requiring that the filter assemblies temporarily stop filtering the SORDS). The filter assemblies 12 separate FCC catalyst solids (cat' fines) from the FCC slurry oil. The filtrand (i.e., the cat' fines) from the SORDS is trapped and collected in the filter assemblies 12. The filtered FCC slurry oil exits the filter assemblies 12 to be delivered to an FCC slurry oil storage tank 16 over piping 18. The filtered FCC slurry oil sent to storage tank 16 is substantially free of catalyst solids, i.e., less than about 200 ppm (about 0.02%) catalyst, and potentially as low as about 20 ppm (about 0.002%). Stated differently, the FCC slurry oil exiting the filter assemblies 12 through piping 18 is at least 99.9% (and preferably about 99.98% to about 99.998%) FCC slurry oil. The SORDS retentate (which is trapped by the filter assembly) comprises cat' fines and FCC slurry oil.

The filter assemblies 12 preferably filter the FCC slurry oil run-down stream via porous metal filtration and/or electrostatic attraction (using charged glass or ceramic beads). A porous metal filter has a void size in the range of 0.5 micron to about 2 microns, which is smaller than the cat' fines (which have an average particle size or APS of about 30 microns). In addition, the filter assemblies 12 can have a diameter of about 24″ to about 48″, and preferably, about 24″ to about 36″, and a height of about 8 feet to about 9 feet (to define a filtering volume of about 250 gallons to about 300 gallons). Such a filter assembly would need to be purged (cleaned) of the entrapped cat' fines, for example, 2-3 times/day. As can be appreciated, the frequency with which the filter assemblies 12 need to be purged or backwashed, will be affected by the size of the filter assemblies (smaller or larger filter assemblies could be used) and by the volume of FCC slurry oil run-down stream passing through the filter assemblies.

To purge or backwash the filter assemblies, a low boiling point solvent (LBPS) is delivered from a LBPS storage 20 over an LBPS line 22 to the filter assemblies 12 to backwash the filter assemblies and remove trapped cat' fines from the filter assemblies 12. The solvent is preferably dimethyl formaldehyde, which has a boiling point of about 132.8° F. (56° C.). Although, as noted above, other solvents can be used. For example, petroleum ether and chloroform would also work. For the filter assemblies 12 to filter the cat' fines from the FCC slurry oil run-down stream (and thus separate or isolate the cat' fines from the FCC slurry oil), the FCC slurry oil run-down stream must have a low viscosity. This is typically met, because the FCC slurry oil run-down stream is hot when it exits the FCC unit. For example, the FCC slurry oil run-down stream can be in excess of 300° F. when it enters the filter assemblies 12. This is substantially above the boiling point of the solvent. The preferred solvent, dimethyl formaldehyde, has a boiling point of about 133° F. Thus, the filter assemblies must be cooled prior to introducing the solvent into the filter assemblies. The filter assemblies can be cooled in any desired manner.

To backwash the filter assemblies, the filter assemblies 12, once cooled, are filled with solvent (the backwash medium). The SORDS retentate may increase in viscosity as the filter assemblies are cooled. However, the solvent introduced into the filter assemblies 12 will reduce the viscosity to enable the retentate to be backwashed from the filter assemblies. When the filter assembly is filled with solvent, the ratio of the solvent to catalyst is at least 2:1 by volume, and can be 4:1, 6:1 or even as high as 8:1 by volume. Thus, the solvent:catalyst ratio can be from about 2:1 to about 8:1, from about 2:1 to about 6:1, from about 2:1 to about 4:1, from about 4:1 to about 6:1 from about 4:1 to about 8:1, or from about 6:1 to about 8:1.

Once the filter assembly is filled with solvent, the filter assembly vents are closed, and the filter assembly is pressurized under a nitrogen atmosphere to about 60 psi to about 80 psi. A valve (not shown) at a bottom of the filter assembly is opened to allow the backwash feed (i.e., the solvent, cat' fines and FCC slurry oil retained on or in the cat' fines) to exit the filter assembly.

Vendors of in-line slurry oil filter assemblies have shown to be proficient in developing automated backwash software and actuated valves that efficiently provide for transfer of the SORDS from one filter assembly to another and back again over the course of back wash cycles.

The backwash feed from the filter assemblies 12 is delivered to a digester 24 over backwash piping 26. The digester can be sized to receive all of the backwash from the filter assemblies 12, such that the digester is operated on a batch basis. The backwash feed contains catalyst (cat' fines) backwashed from the filter assembly, residual FCC slurry oil that has been retained in the pores or on the catalyst surface, and the LBPS that acts as the back wash medium. Additional low boiling point solvent may be delivered to the digester 24 by means of piping 28. This additional solvent delivered to the digester, if used, is the same solvent used to backwash the filter assemblies 12. As noted above, the LBPS dissolves and extracts FCC slurry oil retained on the surface and in the pores of the cat' fines to thereby extract the FCC slurry oil from the catalyst into the LBPS. If a sufficient amount of solvent is used during the backwash of the filter assembly 12, the solvent introduced into the filter assembly should be sufficient to substantially remove or separate the FCC slurry oil in the retentate from the cat' fines. For example, additional solvent should not be necessary if the solvent:catalyst ratio is at least 4:1 by volume.

As seen in the FIGURE, the digester 24 has an upper portion and a lower, cone-shaped portion. The backwash feed is preferably introduced into the digester upper portion. In the digester 24, the backwash feed from the filter assemblies 12 (and any additional LBPS, if added) are agitated using an impeller or agitator 30. The backwash solution generally need not be agitated for very long. Fifteen minutes of agitation is sufficient to ensure that the desired amount of the FCC slurry oil in or on the catalyst in the backwash is extracted from the catalyst. Although an impeller is used to agitate the backwash/LBPS solution in the digester, other methods could be used to agitate the solution in the digester.

After the agitated mixing, the impeller 30 is deactivated and the catalyst constituent is allowed to settle out of the hydrocarbon portion into the lower conical portion of the digester 24. This results in a lower catalyst layer and an upper hydrocarbon layer in the digester. Preferably, the catalyst that settles out is not 100% free of FCC slurry oil. Rather, the catalyst that settles out in the digester contains about 2-4% FCC slurry oil. The upper hydrocarbon layer is comprised primarily of LBPS containing dissolved FCC slurry oil. As can be appreciated, even after the catalyst portion has settled out of the hydrocarbon portion, catalyst particles and ultra-fines may remain in the hydrocarbon portion, and are part of the hydrocarbon layer. Preferably, the cat' fines settle out of the hydrocarbon portion under gravity. The digester can be provided with a second impeller 32 or auger to help force the catalyst from the digester 24 after the catalyst particles have settled. This second impeller 32 or auger is operated to rotate in a direction opposite that of the agitating/mixing impeller 30.

After the catalyst has settled out of the hydrocarbon portion (LBPS and FCC slurry oil), the upper hydrocarbon layer is decanted from the digester. The hydrocarbon layer is initially delivered to a filtration system 34 to remove any unsettled cat' fines. The filtered hydrocarbon layer is then sent to an evaporator 36 where a reboiler provides heat to evaporate (and isolate) the solvent from the FCC slurry oil. The solvent, as noted, is a low boiling point solvent. The preferred solvent, dimethyl formaldehyde, has a boiling temperature of 132.8° F. (56° C.). Thus, the energy requirements to evaporate the solvent are not great. The evaporated LBPS (i.e., LBPS vapor) exits the evaporator over a line 38 and is directed to a chiller 40 where the LBPS vapor is condensed. The liquid LBPS is then sent to the LBPS storage vessel 20 to be reused in the filter assemblies 12 and the digester 24. The FCC slurry oil is removed from the bottom of the evaporator 36 and is delivered to the FCC slurry oil storage tank 16 over piping 42.

Returning to the digester 24, the cat' fines that settle at the bottom of the digester 24 are solvent-moist, and can have a solvent content of about 20% to about 40%. The solvent-moist, settled cat' fines exit the digester 24 through piping 44 which delivers the solvent-moist, settled cat' fines to a drying unit 46. Piping 44 can, for example, incorporate an auger to deliver the solvent-moist cat' fines to the dryer. The drying unit 46 can, for example, be a heated conveyor or auger. In view of the fact that the boiling point of the solvent is low, the drying unit need not heat the solvent-moist cat' fines to a high temperature to evaporate the solvent from the cat' fines (i.e., to dry the cat' fines). For the preferred solvent, dimethyl formaldehyde, the conveyor need only heat the solvent-moist catalyst to a temperature of, for example, 160° F. The residence time of the cat' fines in the dryer depends on the volume of cat' fines being dried, the moisture content, and the dryer temperature. For example, for solvent-moist cat' fines (in which the cat' fines have a moisture content of about 20%) to about 40%), the residence time in the dryer rated to handle about 1666 lbs/hr is about 25 minutes. Obviously, the residence time of the cat' fines in the drying conveyor can be varied by altering the temperature of the drying unit, the solvent content of the cat' fines entering the drying unit, and the thickness of the layer of cat' fines being dried. However, the drying time is sufficient to evaporate substantially all the solvent from the cat' fines, such that the dried cat' fines have a solvent content of less than about 2%, and preferably less than about 0.25%, and even more preferably, about 0%.

The dryer is outfitted with an overhead manifold 48 which receives the LBPS vapors and which directs the LBPS vapor over piping 50 to the chiller 40 for condensation. The now liquid LBPS is directed to the LBPS Storage Vessel 20. The dryer conveyor 46 is shown to slope upwardly from its inlet end 46a where solvent-moist catalyst is fed into the conveyor to its exit end 46b where the dried solvent exits the conveyor. The slope is not so great that it will impede the transport of the catalyst along the conveyer, yet is sufficiently steep to facilitate the collection of LBPS vapors near the top (exit end) of the conveyer. The manifold is positioned toward the upper exit end of the conveyor. This allows for the solvent vapors to flow upwardly through the conveyor, and reduces the possibility of solvent vapors remaining in the conveyor (dryer) housing.

The dried catalyst exits the conveyor at the exit end, and is collected in a hopper

52. The dried catalyst is, as noted above, substantially solvent free, and, as noted above, has a solvent content of less than 2%, and preferably less than about 0.25%, and even more preferably, about 0%. Thus, the dried catalyst is powder-like. With an average size of about 30 microns, the dried catalyst can be handled and transported pneumatically. As noted above, the dried catalyst, although substantially solvent free, contains up to about 4% by weight FCC slurry oil. The slight amount of FCC slurry oil facilitates transportation of the dried catalyst and helps reduce catalyst dust levels. The reclaimed, dry catalyst is preferably returned to the FCCU at a point just upstream of the FCC regenerator. This allows the catalyst to undergo regeneration thereby reactivating the catalyst for service in the FCC conversion process. Alternatively, the catalyst can be transported for disposal.

Importantly, other than the filter assemblies 12, the components of the SORDS purification system operate at ambient pressure. Additionally, the filter assemblies and the digester operate at ambient temperatures. As noted above, the FCCU fractionator 10 operates continuously. However, the filter assemblies 12 need only be back-flushed periodically. Thus, the purification system (i.e., the separation of the FCC slurry oil component and catalyst component of the SORDS retentate, and then the separation of the solvent from the FCC slurry oil and the catalyst) is conducted as a batch operation.

Although not disclosed, one of ordinary skill in the art will recognize that the disclosed system will also include necessary pumping equipment to move the various solutions through the system.

While the specific embodiments have been described, numerous modifications come to mind without significantly departing from the spirit of the invention and the scope of protection should only be limited by the scope of the accompanying claims. For example, the additional solvent that is introduced into the digester (over line 28) could be introduced into the backwash feed passing though piping 26, such that the backwash and additional solvent enter the digester together. Depending on the amount of solvent used to backwash the filter assemblies 12, it may not be necessary to add the additional solvent to the backwashed retentate (feed) to extract and/or separate a desired amount of the FCC slurry oil from the cat' fines in the digester. If the piping delivering the backwash from the filter assemblies 12 to the digester sufficiently agitate the backwash, there may not be any need to mix or agitate the backwash in the digester, and the catalyst portion of the backwash can simply be allowed to settle out of the hydrocarbon portion of the backwash. Although heat is preferred as the method to dry the cat fines, the dryer 46 could rely on vacuum pressure to remove the solvent from the cat fines which exit the digester. These examples are merely illustrative.

1. A method for processing a backwash feed resulting from the backwashing of catalyst retentate filtered from a FCC slurry oil run-down stream (SORDS) generated by a fluid catalytic cracker to separate catalyst fines from FCC slurry oil and to purify the catalyst fines; the backwashed feed comprising catalyst fines backwashed from the filtration, residual FCC slurry oil that has been retained in the pores or on the surface of the catalyst, and low boiling point solvent used as a backwash medium; the method comprising:
a. feeding the backwashed feed to a digester;
b. separating the catalyst fines of the backwash feed from the low boiling point solvent and slurry oil of the backwash feed;
c. decanting the solvent/slurry oil layer from the digester;
d. separating the solvent from the slurry oil;
e. delivering solvent-moist catalyst fines from the digester to a dryer; and
f. drying the catalyst fines.

2. The method of claim 1, further comprising agitating the backwash feed in the digester.

3. The method of claim 1, further comprising adding additional low boiling point solvent to the backwashed catalyst retentate.

4. The method of claim 3 wherein the additional low boiling point solvent is introduced into the digester independently of the backwashed catalyst retentate.

5. The method of claim 1 wherein the step of separating the catalyst fines from the low boiling point solvent and slurry oil comprising allowing the catalyst fines to settle out of the solvent/slurry oil portion by gravity.

6. The method of claim 1 wherein the step (d) of separating the slurry oil from the solvent is accomplished by evaporation.

7. The method of claim 1 including a step of filtering the solvent/slurry oil solution prior to the separating step (d) to remove any remaining catalyst fines from the solution.

8. The method of claim 1 wherein the step of separating the solvent from the slurry oil comprises evaporating the solvent out of the solvent/slurry oil solution.

9. The method of claim 1 including the steps of:
g. isolating the solvent from the solvent/slurry oil portion; and
h. isolating the slurry oil from the solvent/slurry oil portion.

10. The method of claim 9 wherein the isolated solvent is used as at least part of the backwash medium.

11. The method of claim 9 wherein the isolated slurry oil is transferred to a slurry oil storage tank.

12. The method of claim 1 wherein solvent vapor evaporated from the solvent-moist catalyst fines during the drying step is reclaimed.

13. The method of claim 1 including a step (i) of collecting the dried catalyst fines.

14. The method of claim 1 wherein the dryer comprises a conveyor dryer or an auger dryer.

15. The method of claim 14 wherein the conveyor dryer is sloped, such that an entrance end of the conveyor is below an exit end of the conveyor.

16. The method of claim 1 wherein the drying step comprises drying the catalyst such that the catalyst is less than about 2% solvent.

17. The method of claim 1 wherein the drying step comprises drying the catalyst such that the catalyst is less than about 1% solvent.

18. The method of claim 1 wherein, the catalyst delivered to the dryer contains up to about 4% solvent by volume.

19. The method of claim 1 wherein, the catalyst delivered to the dryer contains about 20% to about 40% solvent by volume.

20. (canceled)

21. (canceled)

22. (canceled)

23. A method for processing and purifying a slurry oil run-down stream (SORDS) generated by a fluid catalytic cracker in order to reduce deleterious effects of using FCC Slurry Oil as backwash to an FCCU riser; the method comprising:
a. filtering the FCC slurry oil run-down stream in a filter on a continuous basis to separate catalyst fines in the slurry oil run-down stream from slurry oil of the stream;
b. periodically backwashing the filter with a solvent to remove catalyst fines trapped by the filter from the filtering step to generate a backwashed catalyst retentate, said retentate comprising catalyst fines backwashed from the filtration, residual slurry oil that has been retained in the pores or on the catalyst surface, and low boiling point solvent used as a backwash medium; and
c. processing the backwashed catalyst retentate (i) to substantially remove the slurry oil from the catalyst fines and (ii) to separate the solvent from the catalyst fines and slurry oil.

24. The method of claim 23, wherein said step of processing the backwashed catalyst comprises:
d. feeding the backwashed catalyst retentate to a digester;
e. separating the catalyst fines of the backwash feed from the low boiling point solvent and slurry oil of the backwash feed;
f. decanting the solvent/slurry oil portion from the digester;
g. isolating the solvent from the slurry oil;
h. delivering solvent-moist catalyst fines from the digester to a dryer; and
i. drying the catalyst fines.

25. The method of claim 1 wherein the drying step comprises drying the catalyst such that the catalyst is less than about 0.25% solvent.
